(19) United States
(12) Patent Application Publication
(10) Pub. No.: US 2026/0239493 A1
(43) Pub. Date: Aug. 13, 2026

(54) CONFIGURING A UE FOR MULTICAST RECEPTION

(71) Applicant: CANON KABUSHIKI KAISHA, Tokyo (JP)

(72) Inventors: Yacine EL KOLLI, RENNES (FR); Walaa SAHYOUN, RENNES (FR); Pierre VISA, RENNES (FR)

(21) Appl. No.: 19/156,091

(22) PCT Filed: Feb. 6, 2024
(86) PCT No.: PCT/EP2024/052876

§ 371 Date: Aug. 13, 2025

(30) Foreign Application Priority Data
Feb. 14, 2023 (GB) 2302100.9
May 11, 2023 (GB) 2307022.0

(51) Int. Cl. H04W 76/40; H04L 47/24

(52) U.S. Cl. CPC H04W 76/40; H04L 47/24

(57) ABSTRACT

A method for a User Equipment, UE, of a wireless network is disclosed. The method at the UE comprises receiving scrambling information associated with the MBS session; receiving a configuration message comprising an MBS configuration for continuing receiving MBS data from the previously joined MBS session, the MBS configuration being at least partially scrambled; and performing an unscrambling process on the received MBS configuration using the received scrambling information. A method at the base station is also disclosed.

### FIELD OF THE INVENTION

The present invention generally relates to configuring or setting up a User Equipment, UE, of a wireless communication system for multicast reception and particularly to configuring or setting up multicast reception in non-connected Radio Resource Control (RRC) state (e.g. RRC_INACTIVE state), including the multicast Multicast/Broadcast Service (MBS) Radio Bearer(s), MRB(s).

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations.

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems based on IEEE 802.11 standards, such as Wi-Fi.

Among the requirements for 5G NR, there are service requirements related to multicast and broadcast service, abbreviated as MBS.

For broadcast communication service, the same service and the same specific content data are provided simultaneously to all UEs in a geographical area (i.e. all UEs in the broadcast service area are authorized to receive the data). A broadcast communication service is delivered to the UEs using a broadcast session. For multicast communication service, the same service and the same specific content data are provided simultaneously to a dedicated set of UEs (i.e., not all UEs in the multicast service area are authorized to receive the data). A multicast communication service is delivered to the UEs using a multicast session.

The support of multicast/broadcast techniques enable the network to operate in a more efficient manner than unicast. The identified use cases that could benefit from this MBS feature include public safety and mission critical, V2X applications, IPTV, live video, software delivery over wireless and IoT applications. 3GPP started to build functional support of MBS in 5G NR with Release 17.

In 5G NR, Radio Resource Control (RRC) protocol operates in the control plane between a UE and a base station (gNB), and provides 3 different states for a UE as defined in the 3GPP specifications TS 38.331: RRC_CONNECTED, RRC_INACTIVE, and RRC_IDLE states. At power up, a UE is in RRC_IDLE state, and the UE changes to RRC_CONNECTED state upon an RRC connection establishment with a gNB. If the RRC connection is released then the UE changes back to RRC_IDLE state. When in RRC_CONNECTED state, the RRC connection can be suspended by the gNB, and the UE moves to RRC_INACTIVE state. When the UE is in RRC_INACTIVE state it cannot communicate with the 5G system, but both the gNB and the UE keep track of the RRC connection context. Thus, the transition back to the RRC_CONNECTED state from the RRC_INACTIVE state is faster than the RRC connection establishment from RRC_IDLE to RRC_CONNECTED state.

With the 3GPP Release 17, the reception of MBS broadcast by a UE is allowed when the UE is in RRC_IDLE, RRC_INACTIVE, or RRC_CONNECTED state, and the reception of MBS multicast is allowed when the UE is in RRC_CONNECTED state only. For the Release 18, the plan is to further allow the MBS multicast reception when the UE is in RRC_INACTIVE state. See, for example, 3GPP RP-213568 entitled “New WID: Enhancements of NR Multicast and Broadcast Services” submitted by CATT and entitled (3GPP TSG RAN Meeting #94-e, source CATT), section 3. The objective is to enable a large density of UEs to be receiving multicast data from one cell. Indeed, having UEs in RRC_INACTIVE state leads to a downsize in the control plane footprint of the overall UEs, and thus allows the gNB to handle more UEs. Besides, to always keep UEs in RRC_CONNECTED state is not power efficient. As a result, the advantages of also supporting multicast for UEs in RRC_INACTIVE state have been recognized.

In Release 17, the MBS multicast session follows state transitions as defined in 3GPP TS 23.247 v17.3.0, figure 4.3-1. The 5G nodes involved in MBS session management are described in clause 5.1 “General Architecture” of TS 23.247 v17.3.0. In this document “session” always refers to “MBS session”.

The session management procedures include session creation (7.1.1.2 or 7.1.1.3 of TS 23.247), session activation (7.2.5.2 of TS 23.247), session establishment and join (7.2.1.3 of TS 23.247).

At start the session does not exist. The session is created on demand of the AF (Application Function). As part of the creation process, the MBS session identifier is allocated, a multicast service area is defined, and the session is announced to UEs in the service area. The multicast service area is defined in 3GPP TS 22.146 version 17.0.0, clause 3 “Definitions”. The multicast service area is defined per multicast service. One multicast service can start multiple multicast sessions. A multicast service area can be as big as a PLMN (Public Land Mobile Network) coverage area, but smaller service areas are also possible.

Once the session is created, the first UE to send a join request to that session will trigger the session establishment toward the NG-RAN (gNB(s) included in the multicast service area). Subsequent join request from other UEs will not trigger the session establishment. The session establishment procedure includes PDU session establishment by the UE, session join request by the UE (associating the PDU session to the MBS session), resources reservation from the core to the NG-RAN for the delivery of MBS data for the first join request.

Also once the session is created, the MB-SMF (MBS Session Management Function) can be triggered to activate the session. The trigger condition reflects the availability of the multicast data from the application. The session activation procedure includes NG-RAN resource reservation.

It is only when both the session is activated and the MBS session is established that the NG-RAN will configure the UE for the reception of multicast data.

The launch of the processes of session activation and session establishment answers to different triggers: for session activation, the trigger is the availability of the multicast data from the application and for session establishment, the trigger is the presence of at least one UE in the service area that sends a join request to the multicast session.

The establishment of a MBS session in a UE is performed when the UE is in RRC_CONNECTED state. It is possible that a gNB may then decide to switch the UE to RRC_INACTIVE state before the MBS multicast data are available through the session activation. As a result, when the session is activated the NG-RAN (at least one gNB) will have to notify and configure the UEs that have joined the session but are in RRC_INACTIVE state.

The current version of the specifications does not provide a procedure to notify or configure a UE in RRC_INACTIVE state. UE in RRC_INACTIVE state is not supposed to receive any data from applications and have limited access to the control plane.

In Release 17, a mechanism was proposed to handle the case of broadcast reception in RRC_INACTIVE state. Document TS 38.300 version 17.0.0, in clause 16.10.6.2 explains the use of MCCH (MBS Control Channel) by the gNB to provide the configuration to UEs in any RCC state including the RRC_INACTIVE state. Indeed, the MCCH channel is accessible to UEs RRC_INACTIVE state and it is well adapted to send notifications and configuration parameters. However, the MCCH is accessible to all UEs without restriction which, while acceptable for broadcast services, represents a security breach for MBS multicast services, since the access to the multicast data is subject to prior authorization for each UE during the join procedure. The multicast configuration should be available only to UEs who have acquired the proper authorization during the join procedure.

As part of ongoing discussions for release 18, document R2-2213112 gives the baseline of UE configuration for RRC_INACTIVE reception as follows:
In RRC_CONNECTED state, gNB configures the UE to receive both in RRC_CONNECTED and RRC_INACTIVE states. UE configuration is made using dedicated signalling, like for example RRC signalling.
In RRC_INACTIVE state, the UE uses previously received configuration to continue receiving the multicast data.
In RRC_INACTIVE state, if multicast configuration changes, for example following a session modification, or following UE mobility, updated configuration is provided using an MCCH channel.
If the configuration is not available to the gNB, for example following mobility, the UE is then required to reconnect.

As discussed above, the provision of UE configuration through a combination of SIB and MCCH channel represents a security breach. Therefore, a problem arises regarding how to make sure that UEs that read the MCCH channel have previously joined the MBS or Multicast session.

Qualcomm, in WO2021/150766A1, suggests to scramble the MCCH channel using the G-RNTI (Group Radio Network Temporary Identifier) MAC parameter. The G-RNTI parameter is known only to UEs that have previously joined the multicast session. This suggestion works when there is only one session managed in the cell. However, a G-RNTI may be shared among multiple broadcast and multicast sessions. Thus, UEs that joined at least one session could have access to information related to other sessions without having joined them.

TDTech, in document R2-2210880 (accessible at https://portal.3gpp.org/ngppapp/TdocList.aspx?meetingId=60334) suggests to dedicate a different MCCH channel to each multicast session, which may be referred to as an MCCH-like solution. The main difference then is that MCCH access information is no longer provided by SIB (System information Block) but by dedicated signalling, like RRC. In this way the MCCH access is restricted to UEs having previously joined the session. While this solution solves the security issue it is deficient in that it is not scalable. Until now only one MCCH channel was used for all MBS sessions. These channels are MAC level entities, there is a limited number of free channel identifiers that can be used for MBS purposes. Therefore, this solution would either limit the maximum number of parallel sessions allowed or would require higher costs in MAC to increase the total number of manageable channels.

In the same document (R2-2210880), ZTE suggests to replace the multicast session identifier by an index in the MCCH channel. As long as the index table is only known to UEs having joined the session, it would not matter if MCCH information is public because only UEs who have joined the session would be able to identify the correct configuration set in the MCCH channel. This solution is acceptable in the case of multiple active sessions. However, the session identifiers are public, and so a UE could still access the configuration of all sessions even without knowing the specific identifier of interest, and in the case of single session the UE is sure to match the public session identifier with the MCCH.

### SUMMARY

According to a first aspect of the invention there is provided a method for a User Equipment, UE, of a wireless network, for receiving multicast and broadcast service, MBS, data, the UE having previously joined an MBS session, the method at the UE comprising:
receiving scrambling information associated with the MBS session;
receiving a configuration message comprising an MBS configuration for continuing receiving MBS data from the previously joined MBS session, the MBS configuration being at least partially scrambled; and
performing an unscrambling process on the received MBS configuration using the received scrambling information.

The scrambling information may comprise a higher level identifier. The higher level identifier may comprise a Quality of Service flow identifier.

The scrambling information may comprise a dedicated scrambling key.

The MBS configuration and the scrambling information may be received from a same base station.

The MBS configuration and the scrambling information may be received from different base stations.

The MBS configuration may comprises the scrambling information.

The step of receiving the MBS configuration may be performed during MBS session establishment.

The step of receiving the MBS configuration may be performed during MBS session activation.

The step of receiving the MBS configuration may be performed as part of a pre-configuration process.

The MBS configuration may be an updated version of an MBS configuration of the previously joined MBS session.

The configuration message may be received by the UE in a non-connected Radio Resource Control, RRC, state of the UE.

The configuration message may be an MBS Control Channel, MCCH, message broadcast by a base state of the wireless network.

The step of receiving the configuration message may be performed in response to receiving a notification from the base station of the wireless network.

The notification may be a paging message.

The MBS configuration may comprise an MBS session identifier in a non-scrambled form.

The method may further comprise the step of:
applying the unscrambled received MBS configuration for continuing receiving the MBS data.

According to a second aspect of the invention there is provided a method at a base station of a wireless network controlling a cell on which one or more UE are camping or served, the method comprising:
performing a scrambling process on an MBS configuration for continuing receiving, by a UE, MBS data from an MBS session previously joined by said UE, wherein the scrambling process is performed using scrambling information previously provided to said UE, such that the MBS configuration is at least partially scrambled; and
sending, to the one or more UE, a configuration message comprising the at least partially scrambled MBS configuration.

The scrambling information may have been previously provided to said UE by the base station.

The scrambling information may have been previously provided to said UE by another base station on which said UE was served.

Said UE may have previously joined the MBS session via the base station.

Said UE may have previously joined the MBS session via another base station of the wireless network.

The scrambling information may be only provided to UEs that previously joined the MBS session.

The scrambling information may be unique to the MBS session.

The scrambling information may comprise a higher level identifier. The higher level identifier may comprise a Quality of Service flow identifier.

The scrambling information may comprise a dedicated scrambling key.

The MBS configuration may comprise the scrambling information.

The step of sending the MBS configuration may be performed during MBS session establishment.

The step of sending the MBS configuration may be performed during MBS session activation.

The step of sending the MBS configuration may be performed as part of a pre-configuration process.

The MBS configuration may be an updated version of an MBS configuration of the previously joined MBS session.

The configuration message may be sent to said UE in a non-connected Radio Resource Control, RRC, state of the UE.

The configuration message may be sent using a MBS Control Channel, MCCH.

The configuration message may be sent using the MCCH after a step of sending a notification to said UE. The notification may be a paging message.

The MBS configuration may comprise a MBS session identifier in a non-scrambled form.

The configuration message may further comprise one or more MBS configuration associated with one or more respective MBS sessions, each MBS configuration being at least partially scrambled using a corresponding scrambling information.

The configuration message may further comprise one or more MBS broadcast configurations associated with one or more respective MBS broadcast sessions, wherein each of the MBS broadcast configurations is in a non-scrambled form.

The scrambling information may be a scrambling information to be used to descramble the respective MBS configuration.

According to a third aspect of the invention there is provided a User Equipment, UE, comprising:
a transceiver for providing wireless communication; and
a processor coupled to the transceiver and configured to perform a method in accordance with the first aspect.

According to a fourth aspect of the invention there is provided a base station comprising:
a transceiver for providing wireless communication; and
a processor coupled to the transceiver and configured to perform a method in accordance with the second aspect.

According to a fifth aspect of the invention there is provided a computer program comprising instructions which, when the program is executed by a computer, cause the computer to carry out a method according to the first or second aspect.

According to a sixth aspect of the invention there is provided a computer-readable medium carrying a computer program according to the fifth aspect.

### BRIEF DESCRIPTION OF THE DRAWINGS

Different aspects of the invention will now be described, by way of example only, and with reference to the following drawings in which:

FIG. 1 is a schematic diagram illustrating a first example wireless communication system in which the present invention may be implemented according to one or more embodiments of the invention;

FIG. 2 illustrates a block schematic diagram of an example configuration of a UE in which the present invention may be implemented according to one or more embodiments of the invention;

FIG. 3 illustrates a block schematic diagram of an example configuration of a base station in which the present invention may be implemented according to one or more embodiments of the invention;

FIG. 4 is a flowchart showing the RRC connection states and transitions for a UE in 5G NR systems;

FIG. 5a is a schematic and simplified diagram of an example message flow for session establishment procedure in accordance with an embodiment of the invention.

FIG. 5b is a schematic and simplified diagram of an example message flow for session activation procedure in accordance with an embodiment of the invention.

FIG. 5c is a schematic and simplified diagram of an example message flow for session update procedure in accordance with an embodiment of the invention.

FIG. 5d is a schematic and simplified diagram of an example message flow for UE cell reselection procedure in accordance with an embodiment of the invention.

FIG. 6 is a flow chart illustrating an example method executed by a UE according to an an embodiment of the invention;

FIG. 7 is a flow chart illustrating an example method executed by a gNB according an embodiment of the invention.

### DETAILED DESCRIPTION

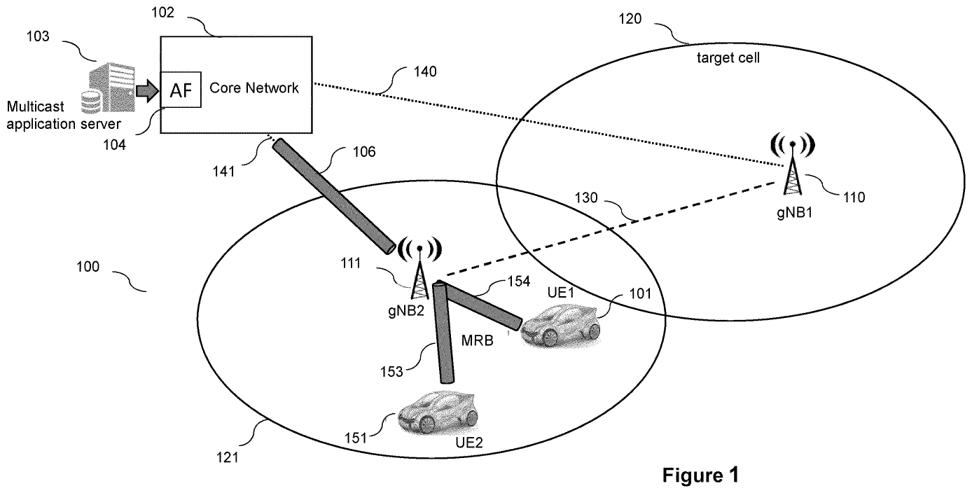

FIG. 1 illustrates an example wireless communication system 100, in particular a mobile radio communication system such as a fifth-generation (5G) New Radio (NR) system supporting multicast and broadcast service (MBS). Although in the following description, embodiments and examples of embodiments of the present invention will be described with respect to a 5G NR system, it will be appreciated that it is not intended that the present invention is limited to 5G NR systems and may be used in any wireless communication systems supporting MBS or similar service.

The system 100 comprises a User Equipment (UE) 101 (or 151), which may be for instance in or part of a vehicle, served by a base station 110 to communicate with a core network, such as the 5G core network 102. The UE may be any wireless device, such as a wireless communication device or apparatus or terminal, IoT device, Machine Type Communication (MTC) device, Device to Device (D2D) terminal, user device (e.g. smart phone, laptop, mobile phone, tablet, camera, game console, wearable device), capable of wireless communication with one or more core networks via one or more Radio Access Networks. The base station 110 is a network node which provides an access point to the core network for a UE and is part of the Radio Access Network (RAN) composed of the base stations 110, and 111. In NR, base stations are referred to as next-generation Node Bs (gNBs), the RAN is a Next Generation (NG) RAN and the core network is referred to as the 5GC. In the following, the terms RAN node, base station and gNB will be used interchangeably. The base stations 110 and 111 are interconnected by means of the Xn interface (specified in the 3GPP document TS 38.423) implemented on the wired or wireless link 130. Each base station is connected to the core network 102 by means of the NG interface (specified in the 3GPP document TS 38.413) implemented on the wired or wireless links 140 and 141.

Each of these base stations controls one or multiple cells. For instance, the base station 110 controls the cell 120, and the base station 111 controls the cell 121. A cell is a geographical area of a radio network defined by the frequency used in the cell to transmit data. The cell can be uniquely identified by a UE from an identification that is broadcasted over a geographical area. Each base station 110, 111 can serve several UEs like the UE 101 or UE 151. Once a UE has established a RRC connection with a base station (as discussed below), the base station, to which the UE is connected, is referred to as the serving base station or source base station of the UE and the cell which is controlled by the serving base station, and on which the UE camps, is referred to as the serving cell. The interface between a gNB and a UE is the Uu interface using the protocol sublayers SDAP (Service Data Adaptation Protocol), PDCP (Packet Data Convergence Protocol), RLC (Radio Link Control), MAC (Medium Access Control), PHY (Physical) in the user plane, and the protocol sublayers RRC (Radio Resource Control), PDCP, RLC, MAC, PHY in the control plane.

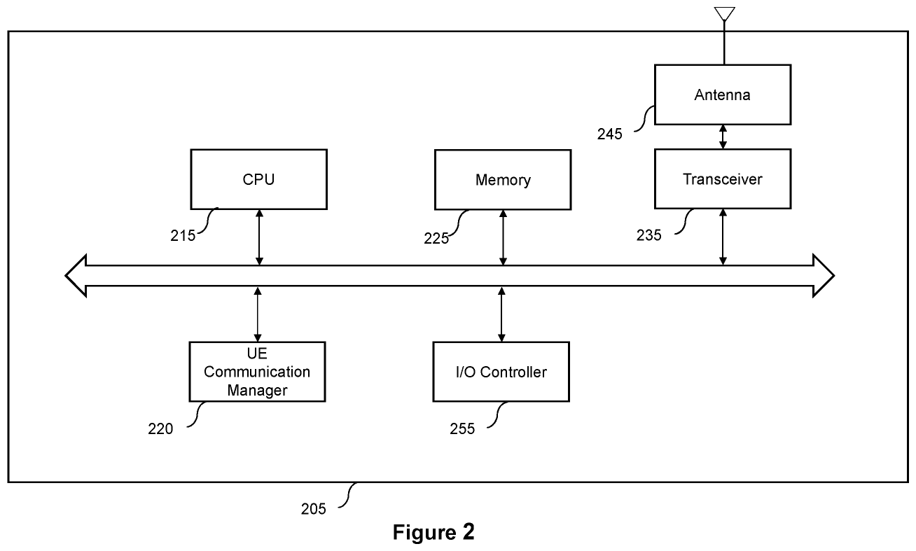

FIG. 2 illustrates a block diagram of a UE device 205, like the UE 101 or UE 151 in the FIG. 1, in which the present invention may be implemented according to one or more embodiments of the invention. The UE includes components for transmitting and receiving communications, including a UE communication manager 220, a I/O controller 255, a transceiver 235, a set of antennas 245, memory 225, and a processor (CPU: Central Processing Unit) 215. All these elements communicate with each other.

Memory 225 includes RAM (Random Access Memory), ROM (Read Only Memory), or combination of both or as a non-limiting example a mass storage device such as a disk or a Solid-State Drive. Basic Input Output System (BIOS) Instructions may be stored within the memory 225.

The processor 215 is configured to execute machine readable instructions. Execution of these machine-readable instructions causes the UE to perform various functions. These functions may be related to transmission or to interaction with peripheral devices like for instance a keyboard, a screen, a mouse, etc. (not shown in FIG. 2). The processor may run an operating system like for instance, iOS, Windows, Android, etc., The processor 215 may be a single processor or may comprise two or more processors carrying out the processing required for the operation of the UE 205. The number of processors and the allocation of processing functions to the processors is a matter of design choice for a skilled person.

The I/O controller 255 allows these interactions with external peripherals by providing the hardware required and by managing input and output signals.

The transceiver 235 is configured to provide bi-directional wireless communication with other wireless devices. For example, it provides the necessary modems and frequency shifters necessary to connect to one or more wireless networks, such as Wi-Fi, Bluetooth, LTE, 5G NR, etc.,

The radio communications use the antenna set 245 adapted to the spectrum of the frequency transposed signals, issued from the baseband modems. The antenna set 245 may be limited to one antenna, but preferably it contains several antennas, in order to provide beamforming capability.

UE communication manager 220 handles the communication establishment of the UE to a Radio Access Network, its control and its release. The UE regularly receives from the base station an indication of slots available for communication between the UE and base station. The UE then knows where in time and frequency it expects incoming data or must send its outgoing data, whether they belong to the control or data plane. In an example implementation, the UE communication manager 220 implements the Uu interface.

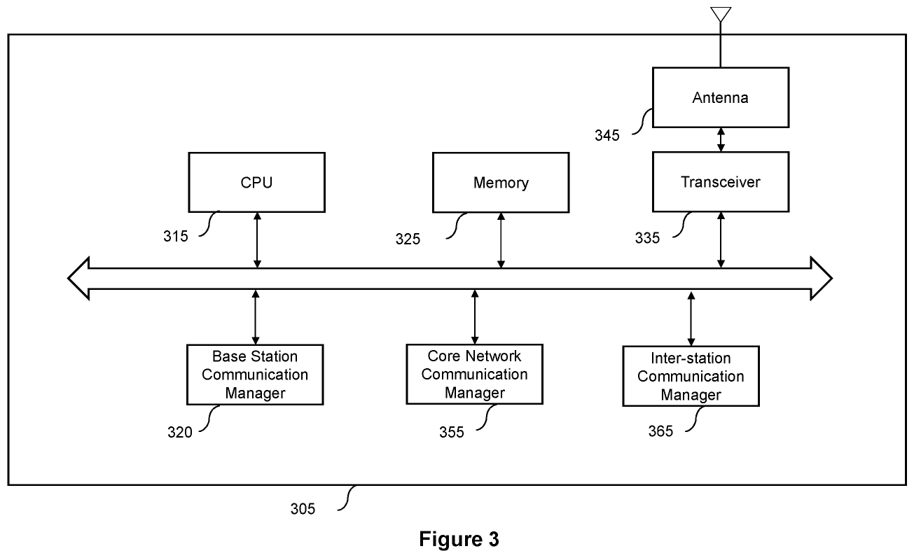

FIG. 3 illustrates a block diagram of a base station device 305, like the base stations or gNBs 110 and 111 in the FIG. 1, in which the present invention may be implemented according to one or more embodiments of the invention. The base station device 305 includes components for transmitting and receiving communications, including a Base Station communication manager 320, a Core Network communication manager 355, a transceiver 335, a set of antennas 345, memory 325, a processor (CPU) 315, and an Inter-Station communication manager 365. All these elements communicate with each other.

The Base Station communication manager 320 handles the communications with a plurality of UEs. It is responsible for the establishment, the control and the release of these communications. In an example implementation, the Base Station communication manager 320 implements the Uu interface. The Base Station communication manager 320 includes a scheduler that allocates time frequency slots to the different UE communications. Information regarding the schedule of these slots is regularly sent to the involved UEs.

The Core Network communication manager 355 manages communications of the base station with the core network. It may provide a standardized NG interface, as defined by the 3GPP standard, to support these communications.

The transceiver 335 is configured to provide bi-directional wireless communication with other wireless devices. These devices may be UEs, or even other base stations. The transceiver 335 provides the necessary modems and frequency shifters in order to connect to a large number of UEs simultaneously, using different frequency carriers, in Time Division Duplex (TDD) or in Frequency Division Duplex (FDD). The transceiver 335 is connected to the antenna set 345, that may be limited to one antenna, but preferably it contains several antennas, in order to provide beamforming capability.

Memory 325 includes RAM, ROM, or combination of both or as a non-limiting example a mass storage device such as a disk or a Solid-State Drive. BIOS Instructions may be stored within the memory 325 to support an operating system.

The inter-station communication manager 365 manages communications with other base stations. The Inter-Station communication manager 365 may provide a standardized Xn interface, as defined by the 3GPP standard, to support these communications.

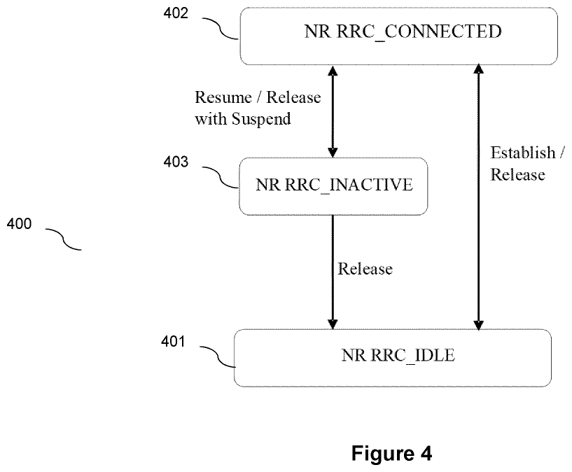

FIG. 4 is a flowchart 400 showing the RRC connection states and transitions for a UE in 5G NR. The RRC protocol operates between a UE and a base station (gNB) and is defined in 3GPP specifications TS 38.331 for 5G NR. The UE's state names are prefixed with “NR” for New Radio. Other prefixes are used for other radio interfaces like LTE radio interface. For the sake of simplicity, the radio technology prefix is omitted in the rest of the description.

Radio Resource Control (RRC) is a layer within the 5G NR protocol stack. It exists only in the control plane, in the UE and in the gNB. The behaviour and functions of a base station and a UE are governed by the current RRC state of the UE. In 5G NR, three distinct RRC states are specified for a UE: RRC_IDLE state 401, RRC_CONNECTED state 402 and RRC_INACTIVE state 403.

At power-up the UE is in RRC_IDLE state 401, it performs radio link quality measurements and executes the cell selection evaluation process (as defined in 3GPP specifications TS 38.304) to identify a target gNB to connect to. The UE state changes to RRC_CONNECTED state 402 upon an RRC connection establishment with the target gNB that becomes the source gNB serving the UE. In the following, the source base station (or source gNB) may also be referred to as the serving base station or serving gNB. If there is no radio activity for a while, the RRC connection can be released by the source gNB, then the UE's RRC state changes back to RRC_IDLE state 401.

While releasing an RRC connection is useful for capacity utilization and power saving, it is not ideal from the latency perspective. The overhead in establishing an RRC connection requires extra signalling that introduces delay. To cope with this drawback, the RRC_INACTIVE state 403 has been introduced for 5G NR. When the UE is in RRC_INACTIVE state 403, the UE cannot communicate with the 5G system, but both the source gNB (e.g. last serving gNB) and the UE store the UE context or configuration. The stored UE context or configuration includes information to facilitate quick resumption of the connection. The information may include the security context (e.g. security parameters such as security key, UE security capabilities), measurement configuration, radio configuration (e.g. UE radio capability), information about bearers, PDU session context etc. Thus, when in RRC_CONNECTED state 402, the RRC connection can be suspended by the source gNB (Release with suspend), and the UE moves to the RRC_INACTIVE state 403. From the RRC_INACTIVE state 403, the UE can be switched back to the RRC_CONNECTED state 402 by the gNB (Resume) and the UE applies the stored UE context or configuration. The RRC resume message is sent by a gNB upon reception of a RRC resume request message from the UE.

From either the RRC_CONNECTED state or RRC_INACTIVE state, the UE can transit to RRC_IDLE state upon a RRC_release command received from the gNB.

The mobility procedure to migrate a UE from one cell to another depends on the UE's RRC state. In RRC_CONNECTED state, the mobility procedure, called handover, is controlled by the network, and the source gNB takes the decision to trigger the handover procedure based on the measurement reports provided by the UE. In RRC_INACTIVE and in RRC_IDLE states (e.g. non-connected states), the mobility procedure is called cell reselection, and it is managed by the UE itself.

In RRC_INACTIVE state, the UE can be configured by the network with a RAN Notification Area (RNA). For example, the message that transitions the UE to the RRC_INACTIVE state contains information indicating the RNA. The RNA is the area within which the UE can move without notifying the network. When the UE in the RRC_INACTIVE state moves to a cell that is not part of its currently assigned RNA, the UE performs a location-update procedure that enables the RAN (e.g. serving gNB) to update the RNA assigned to the UE. In other words, the UE has the possibility to request an RNA update to be informed of a modification of the RNA. When, as part of the cell reselection process, the UE selects a cell managed by a target gNB out of the RNA, the UE sends a resume request to the target gNB, which has three options available: to keep the UE in RRC_INACTIVE state, to set the UE in RRC_IDLE state, or to set the UE in RRC_CONNECTED state.

In RRC_IDLE state, the paging procedure to inform a UE that it has to resume the connection is initiated by the core network. In RRC_INACTIVE state, the paging procedure is initiated by the NG RAN (i.e. the last gNB that had set the UE in RRC_INACTIVE state).

Referring back to FIG. 1, it is assumed that the UE 101 is in the RRC_INACTIVE state and that it is receiving multicast data of one or more multicast MBS sessions generated by the multicast application server 103. The multicast data are provided to the base station 111, which is the base station controlling the cell 121 on which the UE 101 is camping, through the core network 102 and the transport bearer (also known as GTP-U tunnel) 106 over the link 141. Then, the multicast data are transmitted by the base station 111 to the UE 101 through the MBS Radio Bearer (MRB) 154. FIG. 1 also shows the UE 151 receiving data through MRB 153. In a point-to-multipoint transmission of data from the base station 111, the MRB 154 is the same MRB as MRB 153. In a point-to-point transmission, the MRBs 154 and 153 are different. A radio bearer is a set of PHY (layer 1) and MAC (layer 2) parameters allowing higher layer data connection between a UE and a gNB. Multiple types of radio bearers are defined in 5G NR: the SRB (Signalling Radio Bearer) for the control plane, the DRB (Data Radio Bearer) allowing point-to-point communication with one UE in the user plane (unicast), and the MRB allowing point-to-point communication and point-to-multipoint communication with multiple UEs (multicast/broadcast), also in the user plane.

The MBS session join procedure, as specified in 3GPP TS 23.247, is used by UEs to inform the 5GC of an interest in joining a multicast MBS session. The first accepted UE join request triggers the multicast MBS session establishment towards the NG RAN and the UE. Before sending a join request for a multicast MBS session, the UE should have established a PDU session that can be associated with multicast session(s), using the procedures as specified in TS 23.502. Also, the UE should know at least the MBS Session identifier of a multicast group that the UE can join, via service announcement broadcasted by the network. To join the multicast group, the UE sends a PDU Session Modification Request for the associated PDU session which contains one or several MBS session identifier(s) and a join request. The MBS session identifier(s) indicates the multicast MBS session(s) that UE wants to join.

To join an MBS session, the UE has to be in the RRC_CONNECTED state.

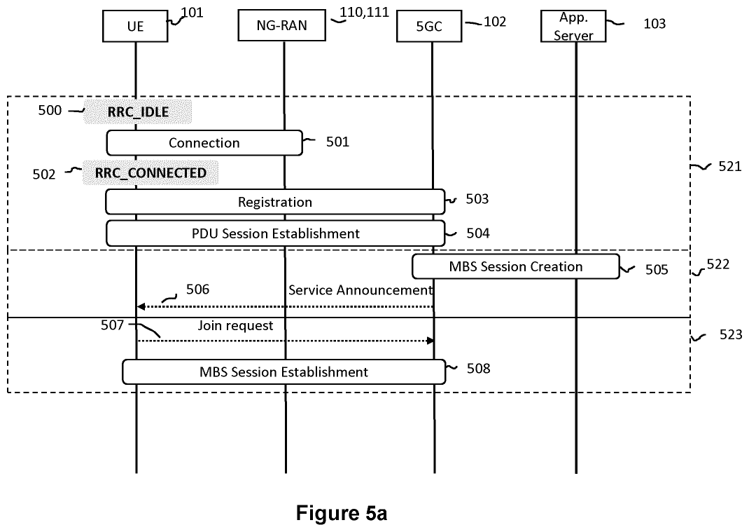

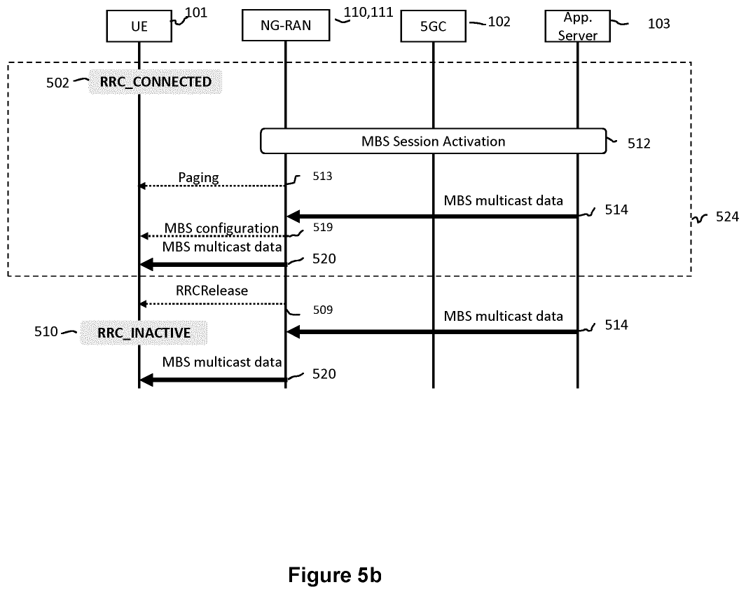

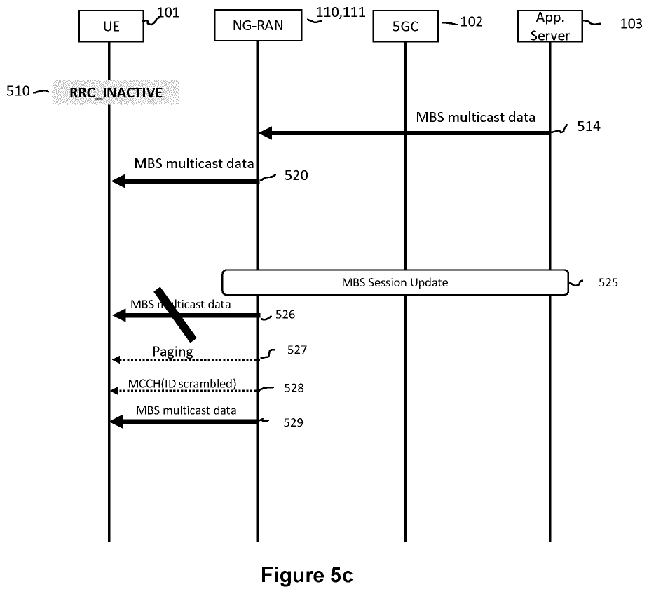

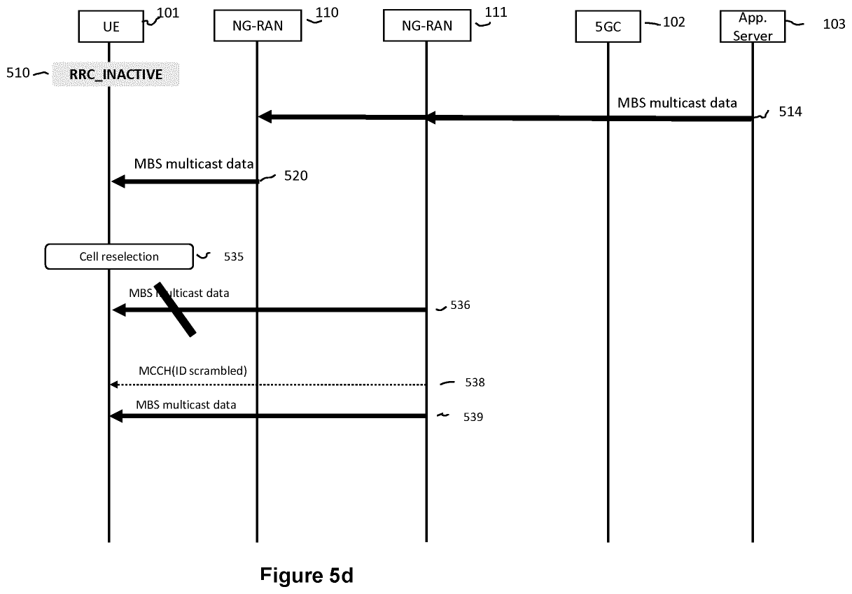

FIGS. 5a, 5b, 5c and 5d together illustrates example message flows for an example scenario of MBS session evolution from creation to activation, update and mobility according to one embodiment of the invention. FIG. 5a illustrates an example message flow for MBS session creation and establishment, FIG. 5b illustrates an example message flow for MBS session activation, FIG. 5c illustrates an example message flow for MBS session update, and FIG. 5d illustrates an example message flow for UE cell reselection procedure.

Referring first to FIG. 5a, a UE, for example UE 101 (or UE 151), is powered up and enters the RRC_IDLE state 500. During step 501, the UE connects to the closest gNB (for example, in the case of FIG. 1, UE 101 connects to gNB 111) as a result of the cell selection process defined in TS 38.304 clause 5.2.3. Once connected to the gNB, the UE enters the RRC_CONNECTED state 502. Then the UE executes the registration process or procedure 503 aiming at identifying the UE in the core network or 5GC 102, checking the UE subscriptions and enforcing the authorisations. The registration procedure is detailed in TS 23.502 clause 4.2.2.2.

After registration, the UE creates a first PDU session via a PDU session establishment procedure 504. The first PDU session is a default PDU session allowing access to 5G core services. This PDU session can be later associated to the MBS session. PDU session establishment procedure is defined in TS 23.502 clause 4.3.2.

The AF (Application function) 104, in the 5G core 102, creates a multicast session on demand of the application server 103. The MBS session creation procedure 505 for creating the multicast session is defined in TS 23.247 clause 7.1.1. The session creation is driven by the AF 104 (Application Function), and on completion, the result is a MBS session identifier (for example, TMGI for Temporary Mobile Group Identity) allocation for the multicast session and session creation.

Once the multicast session is created, the AF 104 performs a service announcement 506 towards the UEs, e.g. the AF 104 sends a service announcement message. The service announcement message includes multicast session information which includes, among other things, the multicast MBS session identifier, service area description (or information) and session description information. Service announcement is described in TS 23.247 clause 6.11. Some UEs may not need to receive the service announcement message: for example, service information provided in the service announcement can be pre-configured at some UEs. Also, UEs that are not connected at the time of the service announcement can access the service information by soliciting directly the AF 104 (Application Function) or MBSF (MBS Service Function) in the core network 102.

There are no timing dependencies between UE connection/registration/PDU session establishment procedures (collectively identified by reference number 521) and MBS session creation/announcement procedures (collectively identified by reference number 522). Both 521 and 522 are performed independently from each other and can happen at any time.

Once the UE 101 is registered in the core network 102 and a default PDU session is established and multicast service information is known, then the UE may send or perform a join request 507 to the core network 102 to enroll in the multicast session. The multicast session information (such as, multicast MBS session identifier, etc. as described above) is known by the UE either after receiving the service announcement message 506, or by pre-configuration, or by soliciting the information from the core network (message flow for pre-configuration of or soliciting session information is not shown in FIG. 5a or 5b). To join a multicast session the UE may reuse the default PDU session created earlier (at 504), and send a PDU session modification request including the multicast session identifier (e.g. TMGI). The PDU session modification request is then considered as a join request (507). Another possibility is to establish a dedicated MBS PDU session including the multicast session identifier for the join request 507.

When the core network 102 receives a join request 507, it performs the multicast session establishment procedure 508. During the session establishment procedure 508, the core network 102 verifies the UE's subscriptions and authorization levels to check if the UE is allowed to access the multicast session (i.e. to check the UE is one of a particular multicast group of UEs authorised to receive the multicast session). Also, as part of the session establishment procedure 508 the core network 102 will setup necessary resources in the core network to covey the multicast data from the application server 103 to the relevant gNBs. The relevant gNBs are defined by the multicast service area information established at session creation step 505. The join procedure 507 and the multicast session establishment procedure 508 are defined in TS 23.247 clause 7.2.1.

During the session establishment procedure 508, the core network may send to the gNB 110,111 MBS session information to be forwarded to the UE. Session information includes at least the MBS session identifier the UE has joined and associated “QoS flow id” (i.e. a Quality of Service flow identifier). The “QoS flow id” is an example of a higher level id, which is allocated by the core network 102 and sent to all gNBs participating in the multicast. This information is sent in the “N2 message request” from the AMF (Access and Mobility Function) to gNB (section 7.2.3.1 of TS 23.247). “N2 message Request” can also be sent during session activation procedure 512. “N2 Message Request” is sent at least once either during session establishment procedure 508 or during session activation procedure 512.

In one embodiment of the invention, the gNB 110, 111 receives a MCCH scrambling key “MCCH_KEY” in “N2 message Request”. MCCH_KEY can be the “QoS flow id” attached to the MBS session, or a dedicated scrambling key. There are benefits to using a higher level id, such the “QoS flow id”, as opposed to a lower layer id (like for example an id defined within the Radio Access Network) used as a scrambling key. For example, the “QoS flow id” is already present in the relevant gNBs and so does not need to be separately generated. Additionally, higher level ids such as “QoS flow id” are the same for all gNBs (as opposed to, for example, G-RNTI (Group radio network temporary identifier), which is allocated by each gNB and is therefore different at each gNB). The “QoS flow id” has been used in the example above, but any other higher level id could be used to obtain similar benefits.

In one embodiment the MBS session establishment procedure 508 is applied between the 5G core 102 and a set of gNBs 110, 111 belonging to a service coverage area. In another example the MBS session establishment procedure 508 is only applied between the 5G core 102 and the gNB 110 hosting a UE that sent the join request 507.

Referring now also to FIG. 5b, with the UE in RRC_CONNECTED state 502.

Once the MBS session is created (505), the AF 104 (Application Function) in the core network 102 can be triggered to activate the multicast session (i.e. MBS session activation 512). The trigger to activate the multicast session is independent from the join and session establishment procedures (collectively identified by reference number 523). One possible trigger is the availability of data from the application server 103. Multicast session activation is described in TS 23.247 clause 7.2.5.2. The main result of this procedure is the RAN (Radio Access Network) resource reservation by the gNBs. These resources allow the communication of the multicast data to the UEs that have already joined the multicast session. The RAN resource allocation includes the MRB configuration (MBS Radio Bearer configuration). Each gNB will use a particular configuration for the MRB for the multicast session.

During the session activation procedure 512, the core network may send to the gNB MBS session information to be forwarded to the UE. Session information includes at least the MBS session identifier the UE has joined and associated “QoS flow id”. This information is sent in the “N2 message request” from the AMF (Access and Mobility Function) to the gNB (section 7.2.3.1 of TS 23.247). “N2 message Request” can also be sent during session establishment procedure 508. “N2 Message Request” is sent at least once either during session establishment procedure 508 or during session activation procedure 512.

In one embodiment of the invention, the gNB receives a MCCH scrambling key “MCCH_KEY” in “N2 message Request”. MCCH_KEY can be the “QoS flow id” attached to the MBS session, or a dedicated scrambling key. In one embodiment the MBS session establishment and activation procedures 508, 512 are applied between the 5G core 102 and a set of gNBs 110, 111 belonging to a service coverage area. In another example the MBS session establishment and activation procedures 508, 512 are only applied between the 5G core 102 and all the gNBs hosting a least one UE that previously sent a join request 507 (not necessarily from the same gNB).

Once the multicast session is activated on completion of the MBS session activation 512, the core network 102 may need to page some UEs to notify them of the availability of the multicast data. The core network 102 sends a group page request to the gNBs with the MBS session identifier (not shown in FIG. 5b), then each gNB sends a group paging request 513 with the multicast session identifier. This sequence is described as step 5 in TS 23.247 clause 7.2.5.2.

It is only at that step when the UE 101 is in RRC_CONNECTED state that the gNB 111 may send the multicast configuration (including the MRB information and MCCH scrambling key) to the UE (see step 519 in FIG. 5b), which includes sending a RRCReconfiguration message (TS 38.331 clause 6.2.2) including the MRB information and MCCH scrambling key “MCCH_KEY”.

In one embodiment of the invention, RRCReconfiguration message further includes necessary configuration for reception in RRC_INACTIVE mode from the serving cell.

In another embodiment of the invention, RRCReconfiguration message further includes necessary configuration for reception in RRC_INACTIVE mode from the neighbour cells.

Once the UE applies the received multicast configuration, it can receive the multicast data in 520.

In the example shown in FIG. 5b, the gNB of the NG-RAN (e.g. gNB 111) decides to switch the UE 101 to RRC_INACTIVE state 510 by sending a RRCRelease message 509 (TS 38.331 clause 6.2.2). The most common reason for such a decision is load management, wherein the gNB may decide to offload its control plane load by switching some UEs to RRC_INACTIVE. UEs and core network may provide additional information to the gNB to help the gNB take the decision to switch some UEs to RRC_INACTIVE state. The additional information may include capacity information from both UE and core network indicating the ability to send or receive multicast data in RRC_INACTIVE state. Other information may also be provided by the UEs to express a preferred state for receiving the multicast data: e.g. RRC_INACTIVE or RRC_CONNECTED.

After receiving the RRCRelease message 509, the UE switches to RRC_INACTIVE state 510, at this point UE may apply different configuration to continue receiving multicast data 520 in RRC_INACTIVE state. The configuration has been received earlier in RRCReconfiguration message (see step 519 in FIG. 5b).

Referring now also to FIG. 5c, with the UE in RRC_INACTIVE state 510, receiving multicast data 520.

In this example, at some point the multicast session parameters are changed by the core network, for example following the session update procedure 525 defined in TS 23.247 section 7.2.6: “Multicast MBS session update procedure is invoked by the AF to update the service requirement (result in multicast QoS parameters update and/or multicast QoS flow addition/removal) and/or MBS Service Area for an ongoing Multicast MBS session.”

In another example, step 525 corresponds to a session activation step similar to 512. In this case, prior data transmissions 514 and 520 do not exist, and so the transmission of MCCH_KEY and MBS configuration was performed earlier after session establishment 508 while UE was in RRC_CONNECTED state.

As a result of multicast session update, the UE must be informed of the new configuration to continue receiving multicast data. Until the new configuration is applied by UE, multicast data cannot be received anymore (as indicated by step 526 in FIG. 5c).

The UE is informed of the new multicast configuration by monitoring the MCCH channel. MCCH channel access method is defined in TS 38.331 clause 5.9.2. MCCH access information may be provided in the System Information Block 20 (SIB20 in TS 38.331 clause 6.3.1).

SIB20 may be broadcast periodically by the gNB of the serving cell, or SIB20 can delivered to the UE by a gNB via dedicated signalling (for example, RRC signalling). In some examples, the SIB20 is sent to the UE via dedicated signalling by the gNB as part of the session establishment procedure 508. In other examples MCCH access information is provided to the UE via dedicated signalling. In another example not shown in this figure, the UE can regularly access MCCH information in case data reception interruption is detected. In yet another example the UE can explicitly request access to MCCH once it has detected data reception interruption.

A gNB may send a notification to the UE (for example, a paging message 527) to indicate that updated information is available in the MCCH.

The content description of MCCH as defined in TS 38.331 clause 6.2.1 describes a MBS broadcast configuration message place holder and a spare place holder.

```
MCCH-Message-r17 ::= SEQUENCE {
  message MCCH-MessageType-r17
}
MCCH-MessageType-r17 ::= CHOICE {
  c1 CHOICE {
    mbsBroadcastConfiguration-r17 MBSBroadcastConfiguration-r17,
    spare1 NULL
  },
  messageClassExtension SEQUENCE { }
}
```

In one embodiment of the invention this spare place holder is used to store the multicast configuration, as shown below.

```
MCCH-Message-r17 ::= SEQUENCE {
  message MCCH-MessageType-r17
}
MCCH-MessageType-r17 ::= CHOICE {
  c1 CHOICE {
    mbsBroadcastConfiguration-r17 MBSBroadcastConfiguration-r17,
    mbsMulticastConfiguration-r18 MBSMulticastConfiguration-r18
},
  messageClassExtension SEQUENCE { }
}
```

For example, the multicast configuration “MBSMulticastConfiguration-r18” may be arranged as an ordered list of per multicast session sets of configuration parameters. Each set of configuration parameters may be scrambled with a scrambling key associated to the respective multicast session and communicated at earlier steps 508 or 519.

A set of multicast configuration parameters includes at least one of the following: access information for Physical Downlink Shared Channel, a list of neighbour cells providing the same MBS session, MBS session identifier (for example TMGI, Temporary Mobile Group Identifier), G-RNTI (Group radio network temporary identifier), MRB (MBS radio bearer) configuration, and/or any parameter described in MBS-sessionInfoList in TS 38.331 clause 6.2.2.

In this way, the MCCH channel is still available to all UEs that acquired the necessary scheduling information for broadcast sessions, and each multicast session information can only be accessed by UE having previously joined the session. For example, a UE that joined a first multicast session is not allowed to access other multicast session information, only the one that it previously joined. Furthermore, multiplexing broadcast and multicast session information in one MCCH channel improves system scalability, and saves MAC level channel identifiers.

In another embodiment, separate multicast and broadcast MCCH channels are used. In that case a multicast specific SIB (System Information Block) may be used to retrieve multicast MCCH access information. Dedicated signalling can also be used to retrieve multicast MCCH access information. This way overhead is reduced for both UEs interested only in broadcast, and UEs interested only in multicast. The extra MAC cost is only one additional channel, and so this solution is still scalable.

In another embodiment, the set of multicast session configuration parameters is partially scrambled, leaving at least the multicast session identifier (for example TMGI, Temporary Mobile Group Identifier) in a non-scrambled form. This way, each UE is easily able to find which set it needs to unscramble.

In step 528 the gNB 110,111 sends the MCCH including the set of multicast configurations corresponding to the UE's multicast session. This configuration set is scrambled by the gNB using the “MCCH_KEY” received earlier as part of the session establishment procedure 508 or as part of the session activation procedure 512. If the “MCCH_KEY” is one of the “QoS flow id” removed upon session update procedure 525, then gNB continues using this “QoS flow id” as the “MCCH_KEY”.

In step 529, the UE successfully unscrambles the MCCH part corresponding to the set of multicast configuration parameters corresponding to the active multicast session, applies this configuration and is now able to receive again the multicast data.

Referring now also to FIG. 5d, with the UE in RRC_INACTIVE state 510.

The UE 101, in RRC_INACTIVE state 510, performs as a background task the cell reselection process 535. This process manages the UE mobility allowing “reselecting” a new gNB depending on the new UE location. Cell reselection is described in detail in TS 38.304 clause 5.2.4. In this example it is assumed that the NG-RAN node controlling the cell on which the UE 101 is camping is gNB 110, and that gNB 111 controls a target cell toward which the UE is moving.

As a result of cell reselection process 535, the UE is now camping on the cell controlled by gNB 111. The UE must be informed of a new configuration to continue receiving multicast data. Until the new configuration is applied by UE, multicast data 536 cannot be received anymore.

In a first example (not represented in this figure), the UE acquired gNB 111 configuration as part of pre-configuration received during step 519. The UE may have favoured gNB 111 to camp on among other neighbour gNBs because the UE had already received the MBS configuration of that gNB.

In another example, the UE did not acquire gNB 111 configuration as part of pre-configuration received during step 519, or gNB 111 configuration has changed since the UE received the pre-configuration 519. In these cases, after cell reselection the UE is not able to receive multicast data 536.

In this example, the UE may be informed of the gNB 111 multicast configuration by monitoring the MCCH channel from gNB 111. MCCH channel access method is defined in TS 38.331 clause 5.9.2. MCCH access information may be provided in the System Information Block 20 (SIB20 in TS 38.331 clause 6.3.1) by gNB 111.

SIB20 may be broadcast periodically by gNB 111. Note that in this example SIB20 cannot be delivered to the UE by gNB 111 via dedicated signalling (for example, RRC signalling) because gNB 111 does not know about the UE camping in RRC_INACTIVE state. In another example, not shown in this figure, the UE can regularly access MCCH information in case data reception interruption is detected. In yet another example, the UE can explicitly request access to MCCH once it has detected data reception interruption. In case this case since the UE is in RRC_INACTIVE state, the request shall be performed following the random access procedure. It is only after a random access procedure by the UE that gNB 111 can send MCCH information to UE by dedicated signalling.

The content description of MCCH is similar to the one already described in relation with FIG. 5c.

In step 538 the gNB 111 sends the MCCH including the set of multicast configurations corresponding to the UE's multicast session. This configuration set is scrambled by gNB using the “MCCH_KEY” received earlier as part of the session establishment procedure 508 or as part of the session activation procedure 512. If the “MCCH_KEY” is one of the “QoS flow id” removed upon session update procedure 525, then gNB continues using this “QoS flow id” as the “MCCH_KEY”.

It may happen that gNB 111 does not have a valid MBS session configuration, for example if the core network 102 has not performed MBS session establishment procedure 508 or MBS session activation procedure 512 with this gNB. In that case the UE is required to perform RRC connection to this gNB and repeat the join request.

In step 539, the UE successfully unscrambles the MCCH part corresponding to the set of multicast configuration parameters corresponding to the active multicast session, applies this configuration and is now able to receive again the multicast data.

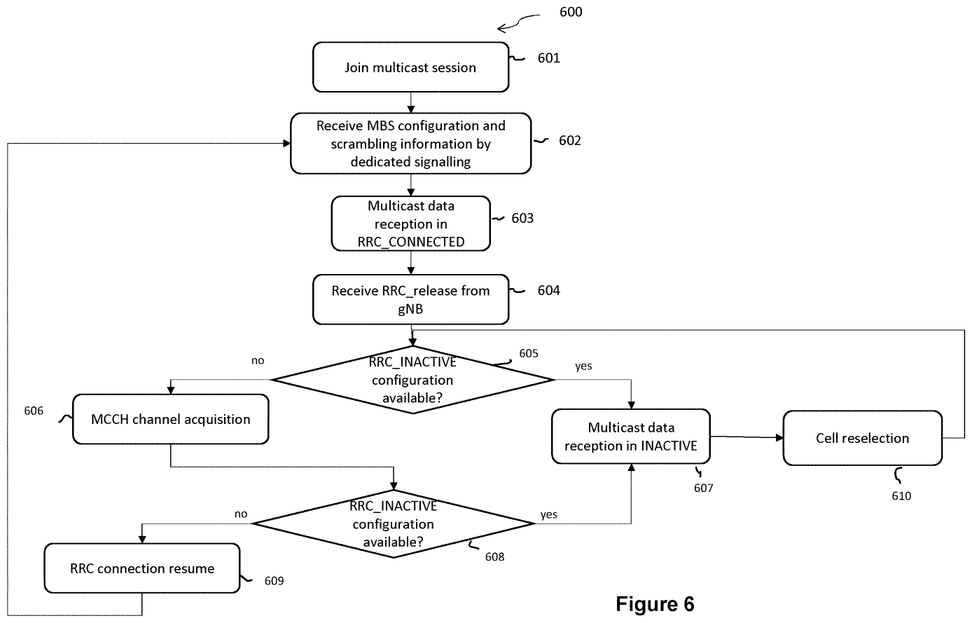

FIG. 6 is a flow chart illustrating an example method 600 executed by a UE according to an embodiment of the invention. This method may be executed by the UE 205 (e.g. by the CPU 215 executing instructions stored in memory 225) of FIG. 2, and corresponds to handling the message flows of FIGS. 5a,b,c,d.

At first during step 601, the communication manager 220 transmits a join request 507 through the transceiver 235 to the core network 102. The join request includes a multicast session identifier (for exp TMGI Temporary Mobile Group Identity) acquired either as part of a pre-configuration process or as part received service announcement 506 sent by 5G core. During this step the UE is in RRC_CONNECTED state.

During step 602, the UE receives Multicast session configuration information including MCCH scrambling parameter “MCCH_KEY” and the session identifier (e.g. TMGI). The multicast configuration is received through dedicated signalling, for example RRCReconfiguration message 519. The configuration message includes at least the “MCCH_KEY” scrambling information and multicast session identifier. It may also include necessary configuration for reception in RRC_INACTIVE mode from the serving cell, and/or necessary configuration for reception in RRC_INACTIVE mode from a neighbouring cell. It may also include a list of neighbour cells providing the same multicast session. It may further include MCCH channel access information (e.g. System information block access). Step 602 can also be triggered by reception by the UE of a page message 513. In an alternative embodiment, Multicast session configuration information is sent in a different message than the MCCH scrambling parameter “MCCH_KEY”. In this embodiment, the session identifier (e.g. TMGI) is sent both with the session configuration and with the scrambling parameter. In this embodiment the Multicast session configuration information including session identifier (e.g. TMGI) is sent in an RRCReconfiguration message 513 and the “MCCH_KEY” and session identifier (e.g. TMGI) are sent in a dedicated signalling message (for example an individual page message).

During step 603, the communication manager 220 configures the transceiver 235 for the reception of multicast data 520 in RRC_CONNECTED state. The configuration information was acquired during previous step 602.

During optional step 604, the communication manager 220 receives from the transceiver 235 a RRC_Release message 509 and changes the UE state to RRC_INACTIVE. Base stations decide to change the states of some UEs as part of load management procedures as described earlier.

During step 605, UE checks if it has the necessary information to continue receiving multicast data while being in RRC_INACTIVE state. Necessary information may have been received earlier during step 602, but configuration may have been changed at gNB side after step 602 or UE may have moved toward another cell, so the UE may not be able to receive multicast data with an outdated configuration.

If the UE is not able to receive multicast data in RRC_INACTIVE state (“no” at step 605), the communication manager 220 configures the transceiver 235 to acquire the MCCH channel broadcast by gNB (step 606). The acquisition method may include acquiring adequate system information block (SIB) like for example SIB20 or another SIB dedicated to multicast. The acquisition method may include using information received earlier in step 602. MCCH content unscrambling is performed by using scrambling key “MCCH_KEY” and multicast session identifier (e.g. TMGI) received earlier at step 602.

At step 608 the communication manager 220 checks if the MCCH acquisition was successful and if the unscrambling of multicast configuration information worked by checking if the transceiver 235 is able to receive the multicast data 529.

In case the acquisition of the configuration information fails (“no” in step 608), during step 609 the UE resumes to RRC_CONNECTED state and cycle back to step 602 to acquire a configuration in RRC_CONNECTED state.

Going back to steps 605 and 608, if the acquisition of suitable configuration for multicast reception in RRC_INACTIVE state is confirmed by the communication manager 220 (“yes” to step 605 or “yes” to step 608), then during step 607, the communication manager 220 configures the transceiver 235 for multicast data reception (step 529 in FIG. 5c, step 539 in FIG. 5d).

During step 610, the UE performs the cell reselection process to evaluate the possibility to connect to a neighbouring cell (controlled by a neighbouring gNB), in case of mobility the communication manager 220 may decide to camp on a new cell (controlled by a new gNB) and will cycle back to step 605 to check if it can continue reception of multicast data from the new/neighbouring gNB. Necessary configuration for reception from the new/neighbouring gNB may have been received earlier at step 602. The selection of the new/neighbouring gNB may have been performed by the UE taking into account the availability of necessary configuration information for some gNBs as received during step 602.

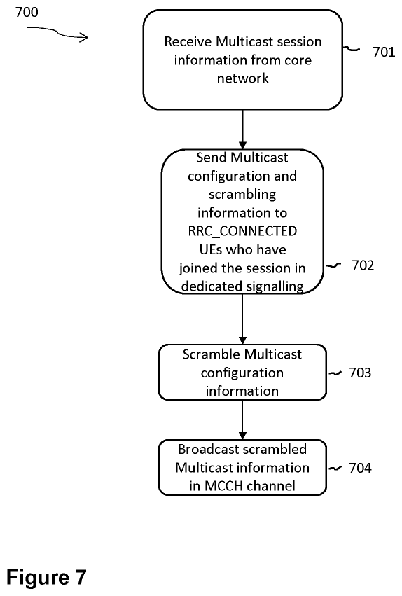

FIG. 7 is a flow chart illustrating an example method 700 executed by a base station (e.g. gNB) according to an example of an embodiment of the invention. This method may be executed by the base station 305 (e.g. by the CPU 315 executing instructions stored in memory 325) of FIG. 3, and corresponds to handling the message flows of FIGS. 5a,b,c,d.

At first, during step 701, communication manager 320 receives from core network communication manager 355 MBS session information. During the session establishment procedure 508, the core network may send to the gNB session information to be forwarded to the UE that has joined the multicast session. Session information includes at least the MBS session identifier the UE has joined and associated “QoS flow id”. This information is sent in the “N2 message request” from the AMF (Access and Mobility Function) to the gNB (section 7.2.3.1 of TS 23.247). “N2 message Request” can also be sent during session activation procedure 512. “N2 Message Request” is sent at least once either during session establishment procedure 508 or during session activation procedure 512. In one embodiment of the invention, the gNB 110,111 receives a MCCH scrambling key “MCCH_KEY” in “N2 message Request”. MCCH_KEY is either one of the “QoS flow id” attached to the MBS session, or a dedicated scrambling key. In one embodiment the MBS session establishment procedure 508 is applied between the 5G core 102 and a set of gNBs 110, 111 belonging to a service coverage area. In another example the MBS session establishment procedure 508 is only applied between the 5G core 102 and the gNB 110 hosting a UE that sent the join request 507.

During step 702 the communication manager 320 performs RAN (Radio Access Network) resource reservation. These resources allow the communication of the multicast data to a UE that has already joined the multicast session. The RAN resources allocation includes the MRB configuration (MBS Radio Bearer configuration). Then the gNB sends the multicast configuration (including the MRB information, MCCH scrambling key and multicast session identifier) to the UE that had previously joined the multicast session (for example, as informed by core network at previous step 701 or by receiving the UE join request message) in a RRCReconfiguration message (TS 38.331 clause 6.2.2). In one embodiment of the invention, RRCReconfiguration message further includes necessary configuration for reception in RRC_INACTIVE mode from the serving cell. In another embodiment of the invention, RRCReconfiguration message further includes necessary configuration for reception in RRC_INACTIVE mode from the neighbouring cells. The RRCReconfiguration message may also include MCCH channel access information, for example System information Block information.

During step 703, the gNB prepares the MCCH channel content. For example, the multicast configuration “mbsMulticastConfiguration-r18” may be arranged as an ordered list of per multicast session sets of configuration parameters. Each set of configuration parameters may be scrambled with the scrambling key associated to the respective multicast session and received at earlier step 701. A set of multicast configuration parameters includes at least one of the following: access information for Physical Downlink Shared Channel, list of neighbour cell providing the same MBS session, MBS session identifier (For example TMGI, Temporary Mobile Group Identifier), G-RNTI (Group radio network temporary identifier), MRB (MBS radio bearer) configuration, and/or any parameter described in MBS-sessionInfoList in TS 38.331 clause 6.2.2.

In another embodiment, separate multicast and broadcast MCCH channels are used. In this case a multicast specific SIB (System information block) may be used to retrieve multicast MCCH access information. Dedicated signalling can also be used to retrieve multicast MCCH access information. In another embodiment, the set of multicast session configuration parameters is partially scrambled, leaving at least the multicast session identifier (for example TMGI, Temporary Mobile Group Identity) in a non-scrambled form.

During step 704, the gNB broadcasts the MCCH channel. MCCH access information may be provided in the System Information Block 20 (SIB20 in TS 38.331 clause 6.3.1). SIB20 may be broadcast periodically by the gNB controlling the serving cell, or SIB20 can delivered to the UE by a gNB via dedicated signalling (for example, RRC signalling). In some examples, the SIB20 is sent to the UE via dedicated signalling by the gNB as part of the session establishment procedure 508. In other examples MCCH access information is provided to UE via dedicated signalling. In another example not shown in this figure, the UE can regularly access MCCH information in case data reception interruption is detected. In yet another example the UE can explicitly request access to MCCH once it has detected data reception interruption. gNB may send a notification to UE (for example a paging message 527) to indicate updated information is available in the MCCH.

In other words and as a summary, the access to MBS multicast data is subject to prior authorization for each UE during the join procedure. Then, the MBS multicast configuration should be available only to the UEs who have acquired the proper authorization during the join procedure.

Similar to Rel-17 broadcast reception procedure, a UE acquires new SIB and multicast MCCH to get PTM, Point To Multipoint, configuration after cell reselection. In practice, the UEs that read the multicast MCCH channel to get PTM configuration for a MBS multicast session should have previously joined this MBS multicast session. However, as the multicast MCCH configuration is provided via new SIB, the MCCH can be accessible to all UEs without restriction which, while acceptable for broadcast services, represents a security breach for MBS multicast services. The security protection of MBS multicast data may be provided by the application layer but this is not guaranteed.

### Multicast MCCH Scrambling:

A mechanism should be provided to restrict the access to a PTM configuration through MCCH to the UEs that have previously joined the corresponding MBS multicast session.

One solution may be to scramble the multicast MCCH content and to provide the key to retrieve the content to the authorized UEs. The key would be provided to the authorized UEs when they are in RRC_CONNECTED stated, for instance at the join procedure.

Thus, it is proposed that the multicast MCCH content may be scrambled so that the content can only be retrieved by authorized UEs.

As the multicast MCCH may convey several PTM configurations for different MBS sessions, it should also be avoided that a UE, authorized to receive a PTM configuration for a MBS multicast session it has joined, can also retrieve PTM configurations for MBS multicast sessions it has not joined.

For this purpose, the content of the multicast MCCH may be scrambled with different keys, each key being associated to one MBS multicast session. Then, each portion of MCCH containing a PTM configuration is scrambled with a key different to the keys used to scramble the other portions containing other PTM configurations. To identify each portion, the MBS session ID (or TMGI) may be included in MCCH content but not scrambled.

Thus, it is proposed that the multicast MCCH content may be scrambled with different keys, each key being associated to one MBS multicast session.

1. A method for a User Equipment, UE, of a wireless network, for receiving multicast and broadcast service, MBS, data, the UE having previously joined an MBS session, the method at the UE comprising:
Receiving, from a base station of the wireless network, scrambling information associated with the MBS session, wherein the scrambling information comprises a higher level identifier allocated by the core network;
Receiving, from a base station of the wireless network, a configuration message comprising an MBS configuration for continuing receiving MBS data from the previously joined MBS session, the MBS configuration being at least partially scrambled; and
performing an unscrambling process on the received MBS configuration using the received scrambling information.

2. (canceled)

3. A method according to claim 1, wherein the higher level identifier comprises a Quality of Service flow identifier.

4. (canceled)

5. A method according to claim 1, wherein the MBS configuration and the scrambling information are received from a same base station.

6. A method according to claim 1, wherein the MBS configuration and the scrambling information was received from different base stations.

7. (canceled)

8. (canceled)

9. (canceled)

10. (canceled)

11. (canceled)

12. (canceled)

13. (canceled)

14. (canceled)

15. (canceled)

16. (canceled)

17. A method according to claim 1, further comprising the step of:
applying the unscrambled received MBS configuration for continuing receiving the MBS data.

18. A method at a base station of a wireless network controlling a cell on which one or more UE are camping or served, the method comprising:
performing a scrambling process on an MBS configuration for continuing receiving, by a UE, MBS data from an MBS session previously joined by said UE, wherein the scrambling process is performed using scrambling information previously provided to said UE, such that the MBS configuration is at least partially scrambled, wherein the scrambling information comprises a higher level identifier allocated by the core network; and
sending, to the one or more UE, a configuration message comprising the at least partially scrambled MBS configuration.

19. A method according to claim 18, wherein the scrambling information was previously provided to said UE by the base station.

20. A method according to claim 18, wherein the scrambling information was previously provided to said UE by another base station on which said UE was served.

21. A method according to claim 18, wherein said UE previously joined the MBS session via the base station.

22. The method of claim 18, wherein said UE previously joined the MBS session via another base station of the wireless network.

23. A method according to claim 18, wherein the scrambling information is only provided to UEs that previously joined the MBS session.

24. A method according to claim 18, wherein the scrambling information is unique to the MBS session.

25. (canceled)

26. A method according to claim 18, wherein the higher level identifier comprises a Quality of Service flow identifier.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. A method according to claim 18, wherein the configuration message further comprises one or more MBS configuration associated with one or more respective MBS sessions, each MBS configuration being at least partially scrambled using a corresponding scrambling information.

39. A method according to claim 38, wherein the configuration message further comprises one or more MBS broadcast configurations associated with one or more respective MBS broadcast sessions, wherein each of the MBS broadcast configurations is in a non-scrambled form.

40. A method of according to claim 38, wherein the scrambling information is a scrambling information to be used to descramble the respective MBS configuration.

41. A User Equipment, UE, comprising:
a transceiver for providing wireless communication; and
a processor coupled to the transceiver and configured to perform a method as recited in claim 1.

42. A base station comprising:
a transceiver for providing wireless communication; and
a processor coupled to the transceiver and configured to perform a method as recited in claim 18.

43. A non-transitory computer-readable medium comprising processor executable code for a programmable apparatus, comprising a sequence of instructions for implementing a method according to claim 1.

44. (canceled)
